(19) United States
(12) Patent Application Publication
(10) Pub. No.: US 2026/0347138 A1
(43) Pub. Date: Nov. 5, 2026

(54) SHEET METAL COIL EDGE PROTECTION MATERIAL DISPENSER

(71) Applicant: Lamiflex Group AB, Nyköping (SE)

(72) Inventor: John Charles KENNISON, Grand Bay, AL (US)

(21) Appl. No.: 19/668,373

(22) Filed: May 5, 2026

(30) Foreign Application Priority Data
May 5, 2025 (SE) 2550429-1

(51) Int. Cl. B65H 35/00; B62B 3/10; B65B 41/16

(52) U.S. Cl. CPC B65H 35/0086; B62B 3/10; B65B 41/16; B65H 35/0093; B65H 2301/5151; B65H 2301/51532; B65H 2402/42

(57) ABSTRACT

A dispenser for dispensing edge-protection material from a conically wound roll includes a roll cradle having a substantially planar frame mounted at a positive tilt angle on a stand. Plane-perpendicular rollers, with axes perpendicular to the frame plane, are distributed along a circle-sector region of a lower portion of the frame to support a mantle side of the roll. Coplanar rollers, with axes parallel to the frame plane, support a gavel side of the roll. During dispensing, the roll rolls on both roller sets and, as its diameter decreases, gravity biases the roll toward the lower circle-sector rollers so that the strip is paid off from a substantially constant feed-off position relative to the cradle. Optional features include a cutter, a slip-length meter, and a wheeled trolley base.

### TECHNICAL FIELD

The present disclosure relates generally to tools and equipment for packaging sheet metal coils. More particularly, the present disclosure relates to a sheet metal coil edge protection material dispenser for manually handling edge protection material stored on a roll.

### BACKGROUND

Coils of sheet metal are commonly wrapped in packaging material to protect the coils, for example coils with sheet metal in the form of steel or aluminium, from atmosphere that may affect the quality of the sheet metal as well as from mechanical damages from impacts during transportation or storage. For satisfying protection, specific edge protection material is usually attached to the gavel edges of the sheet metal coils and wrapped into the package together with the rest of the sheet metal coil.

Such edge protection material is preferably shaped with an L-profile in its cross-section and with slits on at least one of the flanges so that the L-profiled material can be bent to follow the circular shape of the edge of a sheet metal coil. When such edge protection material is stored wound up as a roll it typically forms a conical roll. In the manufacturing plant for sheet metal coils there is often a need to handle such edge protection material manually when attaching it to the sheet metal coils for wrapping.

Various solutions for handling sheet metal coil edge protection material have been proposed, including automated or semi-automated material feeding systems. However, there remains a need for improved, robust, and ergonomically favorable manual dispensing equipment, particularly for conical rolls of slitted L-profile edge protection material, where the roll diameter decreases during dispensing and where the dispensing location should remain predictable to the operator.

### OBJECT

It is an object of the present disclosure to provide an improved sheet metal coil edge protection material dispenser for manual handling of edge protection material, including arrangements that support stable rolling of the roll during dispensing and that maintain a substantially constant feed-off position of the material as the roll diminishes in diameter

### SUMMARY

In one aspect, a sheet metal coil edge protection material dispenser is provided for dispensing edge protection material to be applied on edges of a sheet metal coil. In embodiments, the dispenser comprises a roll cradle configured to accommodate a roll of edge protection material in a leaning position. The roll cradle has a substantially planar roller frame mounted on a roll cradle stand with a positive angle in relation to a foot plane of the roll cradle stand.

In embodiments, a set of plane-perpendicular rollers is mounted on the roller frame with their respective axles oriented perpendicularly in relation to the plane of the frame and mutually distributed along a circle sector of a lower part of the frame. In embodiments, a set of coplanar rollers is mounted on the roller frame with their respective axles oriented in parallel with the plane of the frame and with their respective lengths extending from one or more central parts of the frame towards peripheral parts of the frame.

When placed in an intended operating position, a roll of edge protection material rests with its wide gavel side on the coplanar rollers and with its mantle side on the plane-perpendicular rollers. When rolling off a strip of edge protection material from the roll, the roll rolls on the coplanar rollers with its gavel side and on the plane-perpendicular rollers with its mantle side. As edge protection material is rolled off and the roll diminishes in diameter, the roll continues to lean against the plane-perpendicular rollers. With a suitable selection of the mentioned positive angle and roller arrangement, gravity forces the roll against the lower positioned plane-perpendicular rollers, thereby maintaining the strip feed-off position from the roll at a substantially constant location relative to the roll cradle during dispensing.

In further embodiments, the coplanar rollers have a first respective axle end mounted at central attachment points on a central roll cradle frame part and a second respective axle end mounted at peripheral attachment points on the roll cradle frame. In embodiments, a first subset of coplanar rollers extends toward peripheral attachment points positioned at lower positions on the roll cradle frame and a second subset of coplanar rollers extends toward peripheral attachment points at higher positions on the roll cradle frame, wherein the first subset rollers are shorter than the second subset rollers. This arrangement facilitates smooth rolling and support of the diminishing roll diameter until the roll is empty.

In optional embodiments, the dispenser further comprises a cutter comprising a shearing body with a cutter channel configured to receive and guide the strip of edge protection material past a pivotable shearing blade. In optional embodiments, the dispenser further comprises a lever mechanically coupled to the shearing blade to operate the shearing blade. In optional embodiments, the dispenser further comprises a slip length meter comprising a meter channel configured to guide the strip past an encoder meter wheel and a code detector coupled to a digital length read out display.

In optional embodiments, the roll cradle stand is mounted on a bottom frame that may comprise wheels and a handle to form a trolley. In other embodiments, the roll cradle stand and/or the bottom frame may be mounted to another structure, for example to a shop floor or machine part.

### BRIEF DESCRIPTION OF DRAWINGS

Embodiments are described herein with reference to the accompanying drawings, wherein:

FIG. 1A-1D illustrate schematically an exemplifying embodiment of a sheet metal coil edge protection material dispenser loaded with a roll of edge protection material in different perspective views and side views.

FIG. 2A-2D illustrate schematically an exemplifying embodiment of a sheet metal coil edge protection material dispenser in a perspective view (FIG. 2A), side views (FIGS. 2B and 2D), and top view (FIG. 2C).

FIG. 3 shows an exemplifying embodiment of a cutter comprised in embodiments of the edge protection material dispenser.

FIG. 4 shows an exemplifying embodiment of a slip length meter for metering dispensed length of strips of edge protection material comprised in embodiments of the edge protection material dispenser.

### DETAILED DESCRIPTION OF EMBODIMENTS

The following detailed description is exemplary and explanatory only and is not intended to be restrictive. Like reference numerals refer to like elements throughout the figures.

### General Overview

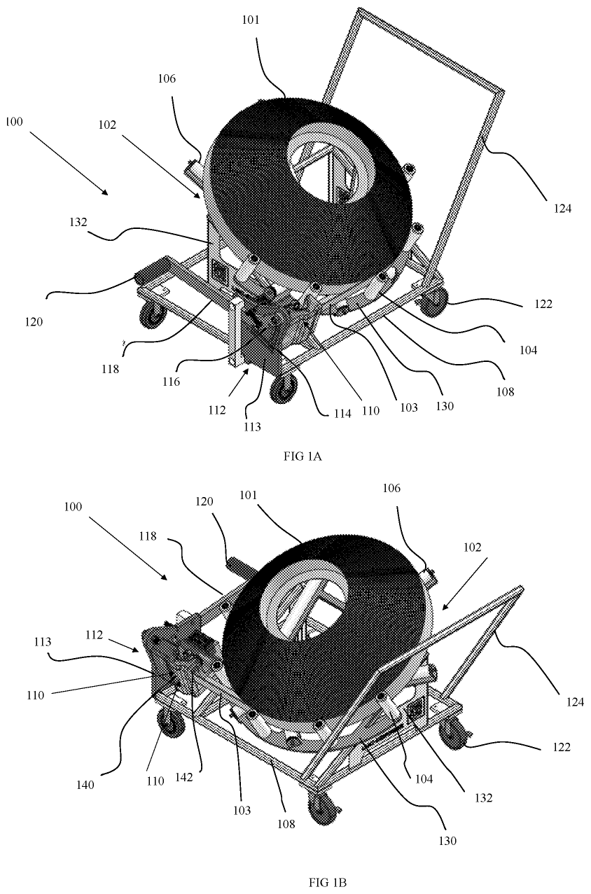

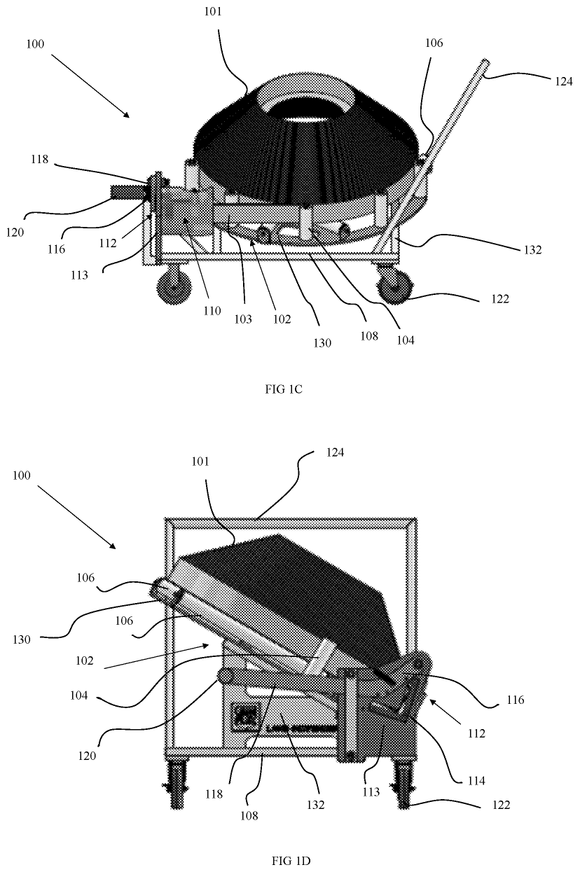

FIG. 1A-1D illustrate an embodiment of a sheet metal coil edge protection material dispenser 100 loaded with a roll 101 of edge protection material. The dispenser 100 is configured for dispensing edge protection material to be applied on edges of a sheet metal coil, for example coils with sheet metal in the form of steel or aluminium.

The illustrated edge protection material is shaped with an L-profile in its cross-section and with slits on at least one of the flanges so that the L-profiled material can be bent to follow the circular shape of a sheet metal coil edge. When such L-profiled slitted material is stored wound up as a roll it forms a conical roll, as visible in FIG. 1A-1D. When a strip 103 of the edge protection material is rolled out, the inner flange of the L-profile with its slits open may show a saw-tooth shape. The dispenser may also be used with edge protection material having a flat cross-section, which when wound up forms a generally cylindrical roll rather than a conical roll.

### Roll Cradle, Roller Frame, and Roller Sets

In the illustrated embodiment, a roll cradle 102 is configured to accommodate the roll 101 of edge protection material in an angled position in relation to a horizontal plane during normal use. The roll cradle 102 includes a substantially planar roller frame 130 mounted on a roll cradle stand 132. The planar roller frame 130 is mounted such that it is inclined with a positive angle in relation to a foot plane of the roll cradle stand 132. In different embodiments the angle may be between 0 and 45 degrees, and in preferred embodiments between 25 and 45 degrees. The foot plane is typically coplanar with the horizontal plane during normal use.

Mounted on the planar roller frame 130 is a set of plane-perpendicular rollers 104. These rollers 104 have respective axles oriented perpendicularly in relation to the plane of the frame 130 and are mutually distributed along a circle sector of a lower part of the frame 130. The “lower part” refers to a region of the frame positioned closer to the foot plane of the stand 132 when the dispenser is in its intended operating orientation.

Also mounted on the planar roller frame 130 is a set of coplanar rollers 106. The coplanar rollers 106 have respective axles oriented in parallel with the plane of the frame 130. In the illustrated embodiments, the coplanar rollers 106 extend with their lengths from one or more central parts of the frame towards peripheral parts of the frame.

### Roll Support and Constant Feed-Off Position

When placed in the intended position, a roll 101 of edge protection material rests with its wide gavel side on the coplanar rollers 106 and with its mantle side on the plane-perpendicular rollers 104. When rolling off a strip 103 of edge protection material from the roll 101, the roll 101 rolls on the coplanar rollers 106 with its gavel side as well as on the plane-perpendicular rollers 104 with its mantle side.

As edge protection material is rolled off, the roll 101 diminishes in diameter and continues to lean against the plane-perpendicular rollers 104. Due to the positive angle of the roller frame 130 and the location of the plane-perpendicular rollers 104 along the lower part of the frame 130, gravity urges the roll 101 toward, and maintains contact with, the plane-perpendicular rollers 104. This geometry provides the technical effect that the strip 103 is fed from the roll 101 at the same position at the roll cradle 102 throughout the dispensing operation, thereby enhancing operator predictability and handling.

### Optional Cutter and Slip Length Meter

From the roll 101, the strip 103 is fed into a channel of an optional slip length meter 110 and/or to a channel of an optional cutter 112. These channels have a respective cross-section similar to that of the edge protection material and a width to allow smooth passage of the strip 103.

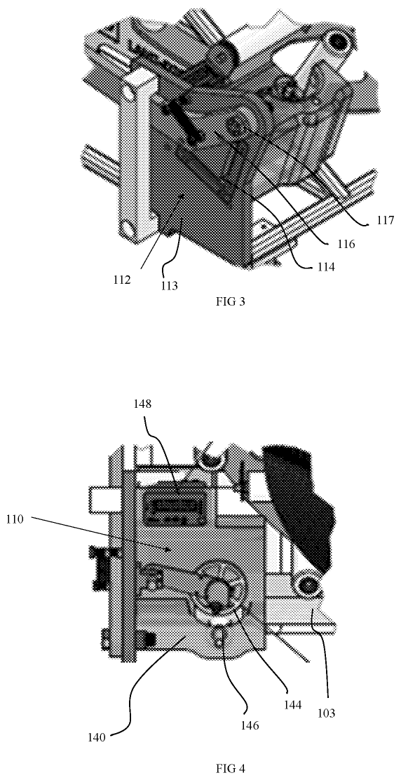

As shown in FIG. 3, embodiments of the dispenser 100 may include a cutter 112 comprising a shearing body 113 with a cutter channel 114 configured to receive and guide the strip 103 past a pivotable shearing blade 116. The dispenser 100 may further include a lever 118 which at one end is mechanically coupled to the shearing blade 116 and at the other end has a handle 120 to operate the shearing blade 116 via the lever 118, thereby pivoting the shearing blade around a shearing blade axis 117.

As shown in FIG. 4, embodiments of the dispenser 100 may further include a slip length meter 110 comprising a slip length meter body 140 having a meter channel 142 configured to receive and guide the strip 103 past an encoder meter wheel 144 configured to lean against and roll with the strip 103 passing through the meter channel 142. The encoder wheel may be decoded by a code detector 146 coupled to a digital length read out display 148 configured to show the length of a dispensed strip 103.

### Frame Structures and Roller Subsets

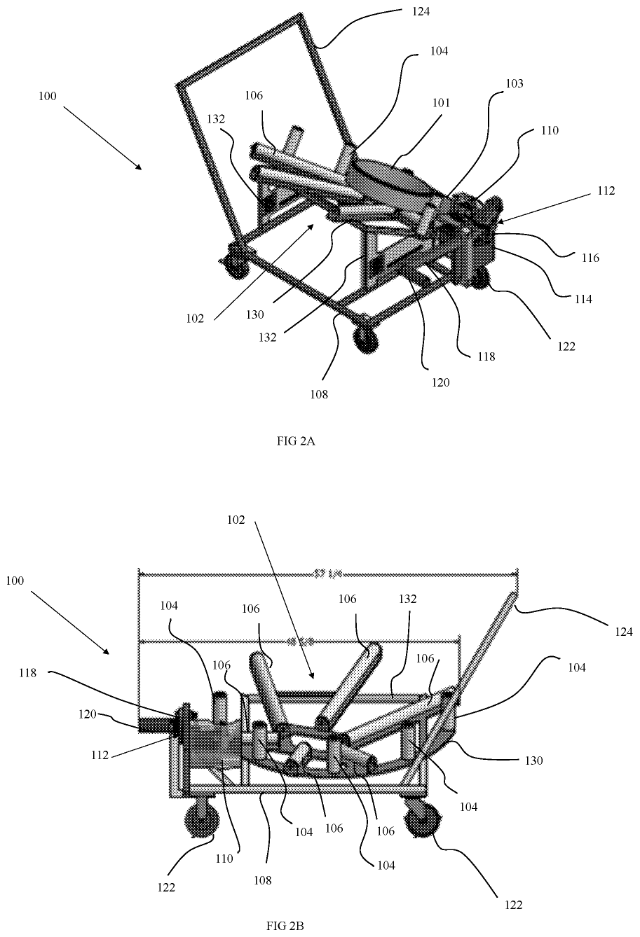

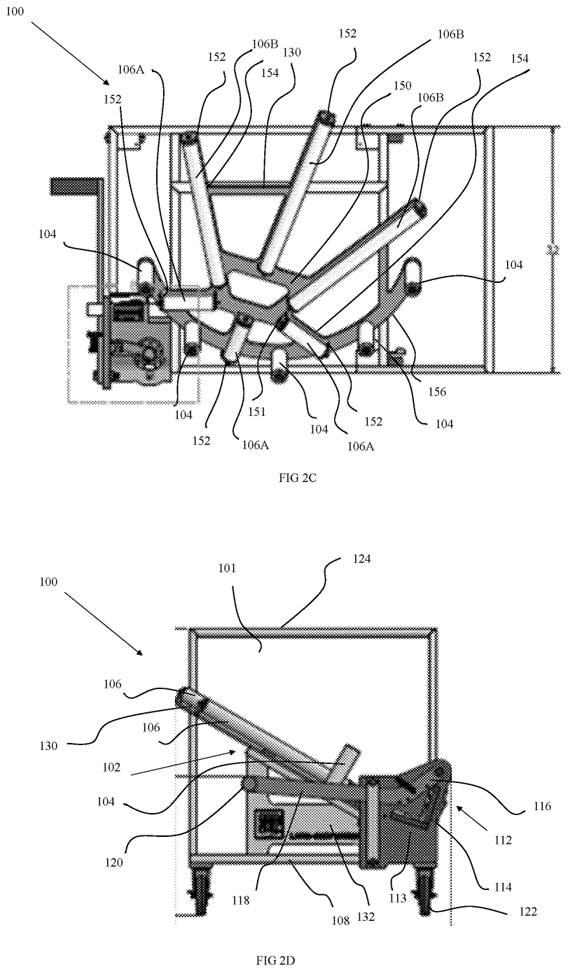

FIG. 2A-2D illustrate an exemplifying embodiment of the dispenser 100 and the roll cradle 102. In embodiments, the coplanar rollers 106 have a first respective axle end mounted at respective central attachment points 151 on a central roll cradle frame part 150 and a second respective axle end mounted at respective peripheral attachment points 152 on the roll cradle frame 130.

In embodiments, a first subset of coplanar rollers 106A extends substantially toward peripheral attachment points 152 positioned at lower positions on the roll cradle frame 130 and a second subset of coplanar rollers 106B extends substantially toward peripheral attachment points 152 positioned at higher positions on the roll cradle frame 130. In typical embodiments, the coplanar rollers 106A of the first subset are shorter than the coplanar rollers 106B of the second subset. This is advantageous to enable the roll 101, with diminishing diameter, to roll smoothly in the roll cradle 102 until the roll is empty.

In embodiments, the above is enabled by positioning the central frame part 150 with an offset downwards from a point corresponding to the center point of a full roll of edge protection material, which supports stable rolling and contact relationships across roll diameters.

The roller frame 130 may be implemented in different structural forms. In one embodiment, the roller frame 130 may be a plate (not shown) with attachment points for the rollers 104, 106. In another embodiment, as illustrated, the roller frame 130 may be shaped with arms similar to a spoke structure and attachment points for rollers 104, 106 at central and peripheral parts of the arms, respectively.

In embodiments, the roller frame 130 comprises a central frame part 150 from which a plurality of roller frame arms 154 extend substantially radially, and a circle sector shaped frame arc 156 attached to a first subset of the roller frame arms 154. In such embodiments, the first subset of coplanar rollers 106A may be mounted with their respective peripheral axle ends on attachment points on said circle sector shaped frame arc 156. In such embodiments, the set of plane-perpendicular rollers 104 may be mounted at one of their respective axle ends on said circle sector shaped frame arc 156.

### Trolley and Mounting

In the embodiments shown in FIG. 1A-1D and FIG. 2A-2D, the roll cradle stand 132 is mounted on a bottom frame 108. The bottom frame 108 may include wheels 122 and a handle 124 to form a trolley that can be moved within a manufacturing facility. In other embodiments, the roll cradle stand 132 and/or the bottom frame 108 may be mounted on other supporting structures, for example directly on a manufacturing shop floor or on a machine part.

The embodiments described herein may be combined in different ways. Further embodiments are set out in the claims.

### Reference list

100 sheet metal coil edge protection material dispenser
101 roll of edge protection material
102 roll cradle
103 strip of edge protection material
104 plane-perpendicular rollers
106 coplanar rollers
108 bottom frame
110 slip length meter
112 cutter
113 shearing body
114 cutter channel
116 shearing blade
118 lever
120 handle
122 wheels
130 roller cradle frame
132 roll cradle stand
140 slip length meter body
142 meter channel
144 encoder meter wheel
150 central frame part
151 central attachment points
152 peripheral attachment points
154 roller frame arms
156 circle sector shaped frame arc

1. A dispenser apparatus for dispensing edge protection material to be applied on edges of a sheet metal coil, the dispenser apparatus comprising:
a roll cradle configured to accommodate a roll of edge protection material, the roll cradle including a substantially planar cradle frame mounted on a cradle stand at a positive tilt angle relative to a foot plane of the cradle stand;
a plurality of plane-perpendicular rollers mounted on the cradle frame with respective axles oriented substantially perpendicular to a plane of the cradle frame and distributed along a circle-sector region of a lower portion of the cradle frame; and
a plurality of coplanar rollers mounted on the cradle frame with respective axles oriented substantially parallel to the plane of the cradle frame,
wherein, in an operating position, the roll is supported with a gavel side of the roll on the coplanar rollers and with a mantle side of the roll on the plane-perpendicular rollers,
and wherein the tilt angle and the arrangement of the plane-perpendicular rollers along said lower circle-sector region are configured such that, as the roll decreases in diameter during dispensing of a strip, gravity maintains the roll bearing against the plane-perpendicular rollers so that a feed-off position of the strip remains substantially constant relative to the roll cradle and the cradle frame.

2. The dispenser apparatus of claim 1, wherein the positive tilt angle is between about 1 degree and about 45 degrees relative to the foot plane of the cradle stand.

3. The dispenser apparatus of claim 2, wherein the positive tilt angle is between about 25 degrees and about 45 degrees.

4. The dispenser apparatus of claim 1, wherein each coplanar roller has a respective axle oriented parallel to the plane of the cradle frame and a respective roller length extending from a more central region of the cradle frame toward a more peripheral region of the cradle frame.

5. The dispenser apparatus of claim 4, wherein the coplanar rollers have first respective axle ends mounted at central attachment points on a central frame part and second respective axle ends mounted at peripheral attachment points on the cradle frame.

6. The dispenser apparatus of claim 5, wherein the coplanar rollers comprise a first subset of coplanar rollers extending toward peripheral attachment points positioned at lower positions on the cradle frame and a second subset of coplanar rollers extending toward peripheral attachment points positioned at higher positions on the cradle frame.

7. The dispenser apparatus of claim 6, wherein coplanar rollers of the first subset are shorter than coplanar rollers of the second subset.

8. The dispenser apparatus of claim 5, wherein the central frame part is positioned with a downward offset relative to a point corresponding to a center point of a full roll of the edge protection material.

9. The dispenser apparatus of claim 1, wherein the cradle frame comprises a central frame part from which a plurality of frame arms extend substantially radially.

10. The dispenser apparatus of claim 9, wherein the cradle frame further comprises a circle-sector shaped frame arc attached to a first subset of the frame arms.

11. A dispenser apparatus for dispensing edge protection material from a roll comprising:
a roll cradle having a substantially planar cradle frame mounted on a cradle stand at a positive tilt angle relative to a foot plane of the cradle stand;
a plurality of plane-perpendicular rollers mounted on the cradle frame with respective axles oriented substantially perpendicular to a plane of the cradle frame and distributed along a circle-sector region of a lower portion of the cradle frame;
a plurality of coplanar rollers mounted on the cradle frame (130) with respective axles oriented substantially parallel to the plane of the cradle frame,
wherein the cradle frame comprises a central frame part and peripheral attachment points, and wherein the coplanar rollers extend with respective lengths from central attachment points on the central frame part toward the peripheral attachment points,
wherein the coplanar rollers comprise a first subset of coplanar rollers extending toward peripheral attachment points positioned at lower positions on the cradle frame and a second subset of coplanar rollers extending toward peripheral attachment points positioned at higher positions on the cradle frame, and wherein the first subset rollers are shorter than the second subset rollers,
and wherein the tilt angle and roller arrangement are configured such that, as the roll diminishes in diameter during dispensing of a strip, gravity biases the roll against the plane-perpendicular rollers in said lower circle-sector region so that a feed-off position of the strip remains substantially constant relative to the roll cradle and the cradle frame.

12. The dispenser apparatus of claim 11, wherein the roll is a conically wound roll formed by edge protection material having an L-profile cross-section with slits in at least one flange.

13. The dispenser apparatus of claim 11, wherein the cradle frame comprises a plurality of frame arms extending substantially radially from the central frame part, and a circle-sector shaped frame arc attached to a first subset of the frame arms.

14. The dispenser apparatus of claim 13, wherein peripheral axle ends of at least the first subset of coplanar rollers are mounted on attachment points on the circle-sector shaped frame arc.

15. The dispenser apparatus of claim 13, wherein at least one axle end of each plane-perpendicular roller is mounted on the circle-sector shaped frame arc.

16. The dispenser apparatus of claim 11, further comprising a cutter comprising a shearing body having a cutter channel configured to receive the strip of edge protection material and to guide the strip past a pivotable shearing blade.

17. The dispenser apparatus of claim 16, further comprising a lever mechanically coupled to the shearing blade and including a handle for operating the shearing blade about a shearing blade axis.

18. The dispenser apparatus of claim 11, further comprising a slip length meter comprising:
a slip length meter body having a meter channel configured to receive the strip and to guide the strip past an encoder meter wheel configured to lean against and roll with the strip, and
a code detector coupled to a digital length read out display configured to show a length of the strip that has passed the slip length meter.

19. The dispenser apparatus of claim 16, wherein at least one of the cutter channel and the meter channel has a cross-section corresponding to a cross-section of the edge protection material and a width that permits smooth passage of the strip.

20. The dispenser apparatus of claim 11, wherein the cradle stand is mounted on a bottom frame comprising wheels and a handle to form a trolley.
